(19) United States
(12) Patent Application Publication
(10) Pub. No.: US 2010/0201627 A1
(43) Pub. Date: Aug. 12, 2010

(54) Communication Device Having Recombination Of Keys And Real-Time Input Method For The Same

(75) Inventor: Kuang-Hui Hung, Taipei (TW)

Correspondence Address: SUTHERLAND ASBILL & BRENNAN LLP, 999 PEACHTREE STREET, N.E., ATLANTA, GA, 30309, US

(73) Assignee: ARIMA COMMUNICATIONS CORPORATION, Taipei (TW)

(21) Appl. No.: 12/368,625

(22) Filed: Feb. 10, 2009

(51) Int. Cl. G06F 3/02

(52) U.S. Cl. 345/168

(57) ABSTRACT

A real-time input method applied for a communication device having recombination of keys is provided in the present invention. The communication device includes a plurality of keys, a screen, and a first and a second combination keys. Each of the plurality of keys is operable for keying in a plurality of characters The input method includes the steps of: (a) providing a character to be keyed in; (b) determining whether the first combination key should be pressed; (c) pressing the first combination key if needed; (d) determining whether the second combination key should be pressed; (e) pressing the second combination key if needed; (f) pressing a specific one of the plurality of keys in the respective character; and (f) displaying the respective character on the screen.

### FIELD OF THE INVENTION

The present invention relates to an input method. In particular, the present invention relates to a real-time input method with recombination of keys applied in the text processing.

### BACKGROUND OF THE INVENTION

Communication devices such as mobile phones, personal digital assistants and global positioning systems, shorten the distances among individuals, and satisfy the individuals' requirements in communication, work and lives. These communication devices usually have the ability to text processing. Users utilize the built-in input methods in the communication devices to press the keys to accomplish text input and send messages to others, or key in texts as the records.

Please refer to FIG. 1, which illustrates a key-in input method in the prior art. In FIG. 1, the mobile phone 10 includes a screen 11, the numeric keys 0˜9, the all-purpose function keys (* and #) and a direction key 13. The user presses the numeric key “2” when desiring to key in the word “COFFIE”, and a letter “A” and a pull down menu represented the letters A, B and C are shown on the screen 11. The user presses the upper button 14 or the lower button 15 of the direction key 13, then picks out the letter “C” and presses the enter button 16 to accomplish the key-in of the letter “C”. The user accomplishes the key-in of the word “COFFIE” or other words according to the above-mentioned steps.

In brief, the steps of the above-mentioned input method includes: (1) keying in the numeric key corresponding to the character; (2) pressing the upper button 14 or the lower button 15 to select the desired character; (3) pressing the enter butter 16; and (4) accomplishing the key-in of the character.

However, the pull down menu 12 corresponding to this input method will represents after keying in the numeric key for a short period time. Further, the desired character cannot be selected immediately, and must be picked out according to the sequence of characters. The usage of the afore-mentioned input method slows down the key-in speed of texts, and users spend more time on editing the texts. Accordingly, quickly keying-in texts or characters in a short time would speed up the efficacy of text processing.

It is therefore attempted by the applicant to deal with the above situation encountered in the prior art.

### SUMMARY OF THE INVENTION

In order to achieve the function of real-time keying-in texts on the present communication device with a limited number of buttons and keying-in texts quickly, the present invention overcomes the drawback of selecting the characters sequentially in the prior art. Users could select the desired characters quickly using the present communication device with a limited number of buttons and accomplish the keying-in or transmission of texts.

In accordance with the first aspect of the present invention, an input method for a communication device is provided. The communication device includes a plurality of keys, a screen, a first combination key and a second combination key, wherein each of the plurality of keys is operable for keying in a plurality of characters. The input method includes steps of: (a) providing a character to be keyed in; (b) determining whether the first combination key should be pressed; (c) pressing the first combination key if a first determination of the step (b) is positive; (d) determining whether the second combination key should be pressed; (e) pressing the second combination key if a second determination of the step (d) is positive; (f) pressing a specific one of the plurality of keys to key in the respective character; and (g) displaying the respective character on the screen.

Preferably, the step (c) and the step (e) cooperate to provide a result selected from a group consisting of: (1) a first result that both of the first combination key and the second combination key are not pressed; (2) a second result that only the first combination key is pressed; (3) a third result that only the second combination key is pressed; and (4) a fourth result that both of the first combination key and the second combination key are pressed.

Preferably, the communication device is one selected from a group consisting of a mobile phone, a personal digital assistant, a global positioning system, a text processor and a combination thereof.

Preferably, the first combination key and the second combination key are mounted on a surface of the communication device or are respectively mounted on two surfaces of the communication device.

Preferably, the screen further comprises a touch panel.

Preferably, the first combination key and the second combination key are displayed on the touch panel.

Preferably, the plurality of keys are configured in a keyboard.

In accordance with the second aspect of the present invention, an input method for a communication device is provided. The communication device includes a plurality of keys, a screen and N combination keys, wherein each of the plurality of keys is operable for keying in a plurality of characters, and N is a positive integer not smaller than two. The input method includes steps of: (a) providing a specific character to be keyed in; (b) determining how many combination keys should be pressed; (c) pressing the determined respective combination keys according to a respective determination of the step (b); (d) pressing a specific one of the plurality of keys to key in the specific character; and (e) displaying the specific character on the screen.

Preferably, the step (c) provides a result of the N combination keys being pressed and having a total number of 2^{N}.

Preferably, the plurality of characters are selected from a group consisting of alphabetic letters, symbols, Arabic numerals and a combination thereof.

In accordance with the third aspect of the present invention, a communication device is provided. The communication device includes: a screen; a plurality of keys, each of which is operable for keying in a plurality of characters classified into at least three groups; and at least two combination keys having at least three statuses, each of which corresponds to one of the least three groups being selected. The screen displays a specific character of the one of the at least three groups being selected when the at least two combination keys are under one of the at least three statuses and a specific one of the plurality of keys corresponding to the specific character is pressed.

Preferably, the at least two combination keys includes a first combination key and a second combination key.

Preferably, the at least two combination keys are mounted on a surface of the communication device, or are mounted on at least two surfaces of the communication device.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates a key-in input method in the prior art;

FIGS. 2(A) to 2(D) are the diagrams showing the real-time input method for the communication device with the recombination of keys in accordance with a first preferred embodiment of the present invention;

FIGS. 3(A) and 3(B) are the diagrams showing the positions of the combination keys on the mobile phone in accordance with a second preferred embodiment of the present invention; and

FIG. 4 is the diagram showing the real-time input method for the communication device with the recombination of keys in accordance with a third preferred embodiment of the present invention.

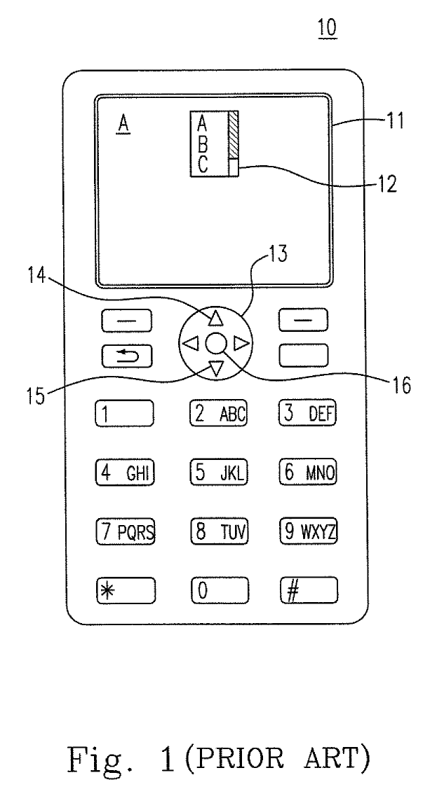

### DETAILED DESCRIPTION OF THE PREFERRED EMBODIMENT

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

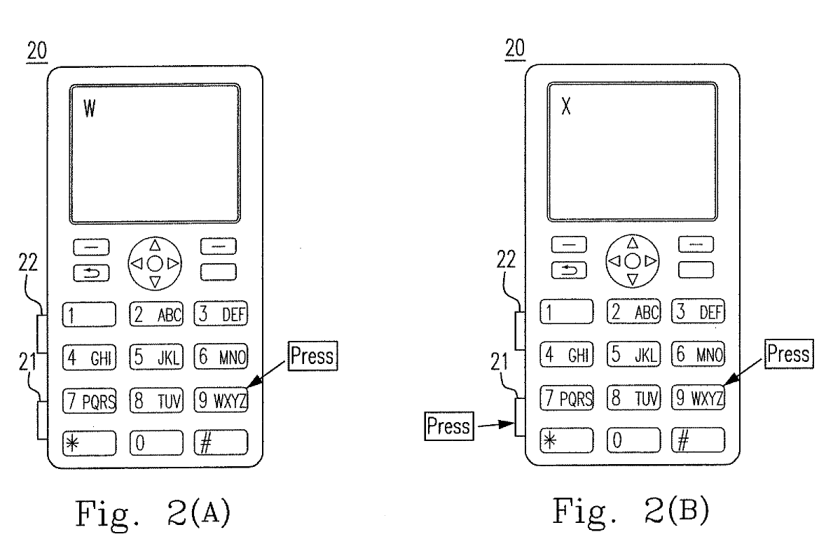

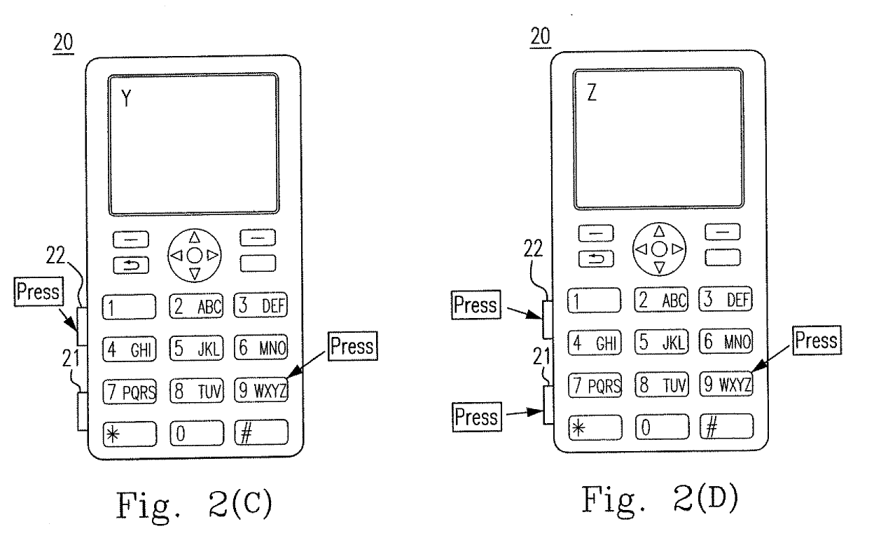

Please refer to FIGS. 2(A) to 2(D), which are the diagrams showing the real-time input method for the communication device with the recombination of keys in accordance with a first preferred embodiment of the present invention. In FIG. 2(A), the mobile phone 20 includes the numeric keys 0˜9 and the combination keys 21 and 22. While desiring to key in the alphabetic letter “W” using English input method, the user merely presses the numeric key 9 but does not press the combination keys 21 and 22, and the alphabetic letter “W” displays on the screen. In FIG. 2(B), the user presses the combination key 21 and then keys in the numeric key 9 while desiring to key in the alphabetic letter “X”, and “X” displays on the screen. In FIG. 2(C), the user presses the combination key 22 and then keys in the numeric number 9 while desiring to key in the alphabetic letter “Y”, and “Y” displays on the screen. In FIG. 2(D), the user presses the combination key 21 and 22 together and then keys in the numeric number 9 while desiring to key in the alphabetic letter “Z”, and “Z” displays on the screen.

The steps of keying-in the combination key 21 and/or 22 in the present real-time input method is similar with the numbers 0 and 1 in the computer language, Zero (0) means that keying in the combination key 21 and/or 22 is un-needed, and one (1) means that keying in the combination key 21 and/or 22 is needed. As the example of keying in the alphabetic letters W, X, Y and Z, the input method can be simplified as follows.

| 21 | 22 | Combination key |
|---|---|---|
| 0 | 0 | W |
| 1 | 0 | X |
| 0 | 1 | Y |
| 1 | 1 | Z |

In addition, the numeric key 2 having three selections of the alphabetic letters A, B and C is being another instance. When desiring to input the alphabetic letter A, B or C, the operation that the combination key 21 or 22 is not pressed but the numeric key 2 is keyed in represents to input the alphabetic letter A, other operation that the combination key 21 is pressed and the numeric key 2 is keyed in represents to input the alphabetic letter B, and another operation that only the combination keys 21 is pressed and the numeric key 2 is keyed in represents to input the alphabetic letter C. However, the operation that the combination keys 21 and 22 are pressed together and then the numeric key 2 is keyed in does not represent any meanings. As the example of keying in the alphabetic letters A, B and C, the input method can be simplified as follows.

| 21 | 22 | Combination key |
|---|---|---|
| 0 | 0 | A |
| 1 | 0 | B |
| 0 | 1 | C |

The steps of the present real-time input method of the communication device having recombination of keys includes: (1) determining the desired character; (2) pressing the combination key 21 and/or 22; (3) pressing the numeric number corresponded to the desired character; and (4) accomplishing the key-in of the desired character. In fact, the keying-in operations are only the steps 2 and 3. Comparing with the input method of the prior art, the present invention obviously omits one step.

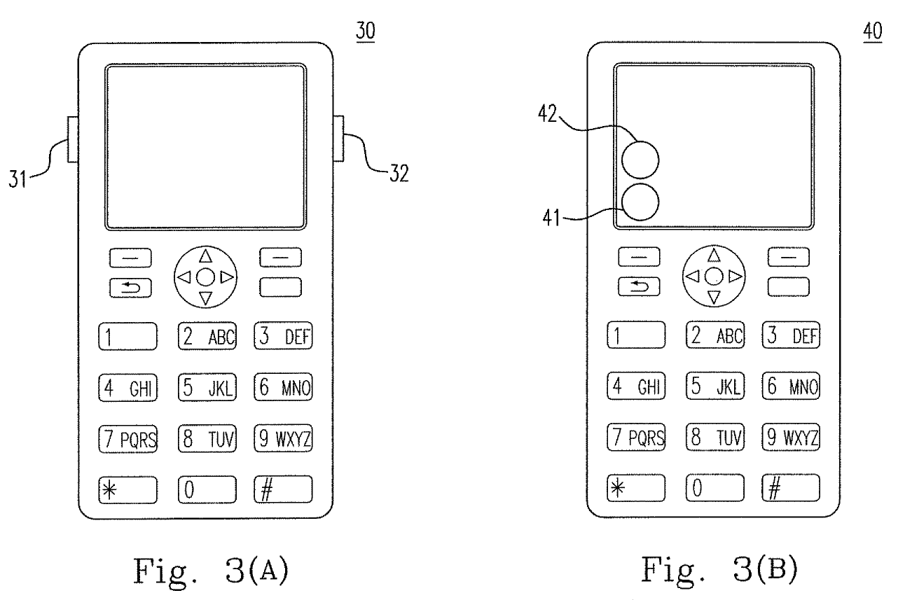

The combination keys of the present invention can be mounted in any positions on the communication devices. As the example of FIGS. 2(A) to 2(D), the combination keys 21 and 22 are mounted parallelly to the identical surface of the mobile phone 20. However, the combination keys 31 and 32 in FIG. 3(A) are mounted on the left and right surfaces of the mobile phone 30. In FIG. 3(B), the screen of the mobile phone 40 is a touch panel. The combination keys 41 and 42 is shown as two icons on the screen of the mobile phone 40, not the concrete keys mounted on the surface of the mobile phone 40. Users touch to press the combination keys 41 and/or 42, then key in the numeric keys of the keyboard to accomplish the operation of keying-in the characters. The positions of the combination keys can be mounted on different positions of the communication keys according to the human factors engineering.

As the example of the real-time input method in the embodiments 1 and 2, fourteen keys are merely needed in the communication device to satisfy the requirements to input English alphabetic letters, Chinese phonetic alphabets and other language letters. The real-time input method of the present invention sufficiently utilizes the deposition of the keys, and achieves the effect of real-time keying in texts.

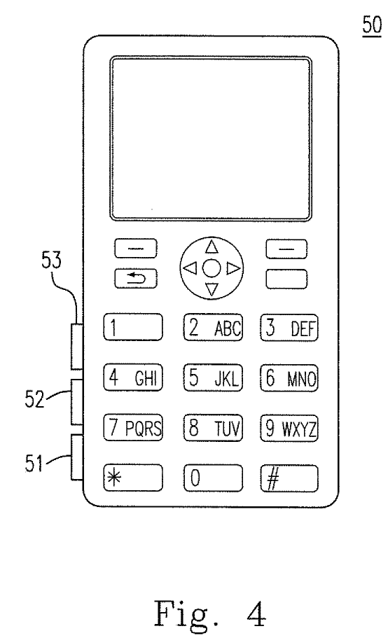

In addition, the number of the combination keys of the present real-time input method is not limited in two, and the number thereof might be three or more. When the number of the combination keys is three, eight combinations (2×2×2) are generated corresponding to the numbers 0 and 1 of the computer language. These eight combinations can be applied in quickly inputting units and symbols. Alternatively, these combinations can be applied in the input of the capital and lowercase letters in English. Please refer to FIG. 4, which illustrates the diagram showing the real-time input method for the communication device with the recombination of keys in accordance with a third preferred embodiment of the present invention. In FIG. 4, the combination keys 51, 52 and 53 are mounted on one surface of the mobile phone 50. Zero (0) means that the combination key 51, 52 and/or 53 need not to be pressed, and one (1) means that the combination key 51, 52 and/or 53 need to be pressed. As the example of keying in the capital alphabetic letters W, X, Y and Z and the their lowercase letters, the input method can be simplified as follows.

| 51 | 52 | 53 | Combination key |
|---|---|---|---|
| 0 | 0 | 0 | W |
| 0 | 0 | 1 | w |
| 1 | 0 | 0 | X |
| 1 | 0 | 1 | x |
| 0 | 1 | 0 | Y |
| 0 | 1 | 1 | y |
| 1 | 1 | 0 | Z |
| 1 | 1 | 1 | z |

In accordance with the design of three combination keys, users can only press the combination keys 51 and/or 52 and/or 53 without switching the capital and lowercase letters of the English input method to accomplish the keying-in of the capital and lowercase letters in English.

The present input method with the combination of keys can be enlarged to N combination keys, which can be paired with the keyboard with the limited number of keys to satisfy more keying-in combinations.

Comparing with the input method in the prior art, the present real-time input method need not to sequentially select the desired characters in one numeric key representing various characters, and need not to press the enter button to identify the selected character. Furthermore, the present real-time input method of the communication device with combination of keys need not to learn excessively or memorize the key-in sequence of each character. It only needs to operate the present input method frequently to achieve the effect of keying in texts rapidly. Further, the language of the present input method is not limited in English alphabetic letters, it also include Chinese phonetic alphabets, other language letters and symbols, etc. Even, other buttons on the communication device can be the combination keys without increasing the design of the new combination keys, and the operation of the present input method can be achieved by amending or increasing the input software.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An input method for a communication device comprising a plurality of keys, a screen, a first combination key and a second combination key, wherein each of the plurality of keys is operable for keying in a plurality of characters, and the input method comprising steps of:
(a) providing a character to be keyed in;
(b) determining whether the first combination key should be pressed;
(c) pressing the first combination key if a first determination of the step (b) is positive;
(d) determining whether the second combination key should be pressed;
(e) pressing the second combination key if a second determination of the step (d) is positive;
(f) pressing a specific one of the plurality of keys to key in the respective character; and
(g) displaying the respective character on the screen.

2. The input method according to claim 1, wherein the step (c) and the step (e) cooperate to provide a result selected from a group consisting of:
(1) a first result that both of the first combination key and the second combination key are not pressed;
(2) a second result that only the first combination key is pressed;
(3) a third result that only the second combination key is pressed; and
(4) a fourth result that both of the first combination key and the second combination key are pressed.

3. The input method according to claim 1, wherein the communication device is one selected from a group consisting of a mobile phone, a personal digital assistant, a global positioning system, a text processor and a combination thereof.

4. The input method according to claim 1, wherein the first combination key and the second combination key are mounted on a surface of the communication device.

5. The input method according to claim 1, wherein the first combination key and the second combination key are respectively mounted on two surfaces of the communication device.

6. The input method according to claim 1, wherein the screen further comprises a touch panel.

7. The input method according to claim 6, wherein the first combination key and the second combination key are displayed on the touch panel.

8. The input method according to claim 1, wherein the plurality of keys are configured in a keyboard.

9. An input method for a communication device comprising a plurality of keys, a screen and N combination keys, wherein each of the plurality of keys is operable for keying in a plurality of characters, N is a positive integer not smaller than two, and the input method comprises steps of:
(a) providing a specific character to be keyed in;
(b) determining how many combination keys should be pressed;
(c) pressing the determined respective combination keys according to a respective determination of the step (b);
(d) pressing a specific one of the plurality of keys to key in the specific character; and
(e) displaying the specific character on the screen.

10. The input method according to claim 9, wherein the step (c) provides a result of the N combination keys being pressed and having a total number of 2^{N}.

11. The input method according to claim 9, wherein the plurality of characters are selected from a group consisting of alphabetic letters, symbols, Arabic numerals and a combination thereof.

12. A communication device, comprising:
a screen;
a plurality of keys, each of which is operable for keying in a plurality of characters classified into at least three groups; and
at least two combination keys having at least three statuses, each of which corresponds to one of the least three groups being selected,
wherein the screen displays a specific character of the one of the at least three groups being selected when the at least two combination keys are under one of the at least three statuses and a specific one of the plurality of keys corresponding to the specific character is pressed.

13. The communication device according to claim 12, wherein the at least two combination keys comprises a first combination key and a second combination key.

14. The communication device according to claim 12, wherein the at least two combination keys are mounted on a surface of the communication device.

15. The communication device according to claim 12, wherein the at least two combination keys are mounted on at least two surfaces of the communication device.
